(19) United States
(12) Patent Application Publication
(10) Pub. No.: US 2022/0082452 A1
(43) Pub. Date: Mar. 17, 2022

(54) TEMPERATURE SENSOR ELEMENT

(71) Applicant: SUMITOMO CHEMICAL COMPANY, LIMITED, Tokyo (JP)

(72) Inventors: Megumi HAYASAKA, Osaka-shi (JP); Yuichiro KUNAI, Toyonaka-shi (JP)

(73) Assignee: SUMITOMO CHEMICAL COMPANY, LIMITED, Tokyo (JP)

(21) Appl. No.: 17/419,582

(22) PCT Filed: Mar. 4, 2020
(86) PCT No.: PCT/JP2020/009083

§ 371 Date: Jun. 29, 2021

(30) Foreign Application Priority Data
Mar. 29, 2019 (JP) 2019-068128

(51) Int. Cl. G01K 7/22; C08L 79/08; C08J 5/18

(52) U.S. Cl. CPC G01K 7/22; C08L 79/085; C08J 5/18; C08L 2203/20; C08J 2479/02; C08L 2205/02; C08J 2379/08

(57) ABSTRACT

There is provided a temperature sensor element including a pair of electrodes and a temperature-sensitive film disposed in contact with the pair of electrodes, in which the temperature-sensitive film includes a conjugated polymer and a matrix resin.

### TECHNICAL FIELD

The present invention relates to a temperature sensor element.

### BACKGROUND ART

There has been conventionally known a thermistor-type temperature sensor element including a temperature-sensitive film changed in electric resistance value due to the change in temperature. An inorganic semiconductor thermistor has been conventionally used in the temperature-sensitive film of such a thermistor-type temperature sensor element. Such an inorganic semiconductor thermistor is hard, and thus a temperature sensor element using the same is usually difficult to have flexibility.

Japanese Patent Laid-Open No. H3-255923 (Patent Literature 1) relates to a thermistor-type infrared detection element using a polymer semiconductor having NTC characteristics (Negative Temperature Coefficient; characteristics of the reduction in electric resistance value due to the rise in temperature). The infrared detection element detects infrared light by detecting the rise in temperature due to incident infrared light, in terms of the change in electric resistance value, and includes a pair of electrodes and a thin film including the polymer semiconductor containing an electronically conjugated organic polymer partially doped, as a component.

### CITATION LIST

### Patent Literature

Patent Literature 1: Japanese Patent Laid-Open No. H3-255923

### SUMMARY OF INVENTION

### Technical Problem

The thin film in the infrared detection element disclosed in Patent Literature 1 is formed by an organic substance, and thus flexibility can be imparted to the infrared detection element.

However, the thin film is not necessarily large in dependence of the electric resistance value on the temperature (the amount of change in electric resistance value in a certain amount of change in temperature, namely, the temperature dependence of the electric resistance value), and thus a temperature sensor element with the thin film as a temperature-sensitive film has room for improvement in accuracy of temperature measurement. Such a temperature sensor element with the thin film as a temperature-sensitive film also has room for improvement in durability over time of the temperature-sensitive film.

An object of the present invention is to provide a thermistor-type temperature sensor element including a temperature-sensitive film including an organic substance, in which the temperature sensor element is improved in accuracy of temperature measurement and in durability over time of the temperature-sensitive film.

### Solution to Problem

The present invention provides the following temperature sensor element.

[1] A temperature sensor element including a pair of electrodes and a temperature-sensitive film disposed in contact with the pair of electrodes, wherein the temperature-sensitive film includes a conjugated polymer and a matrix resin.

[2] The temperature sensor element according to [1], wherein the temperature-sensitive film includes the matrix resin and a plurality of conductive domains contained in the matrix resin, and the conductive domains include the conjugated polymer and a dopant.

[3] The temperature sensor element according to [1] or [2], wherein the matrix resin includes a polyimide-based resin.

[4] The temperature sensor element according to [3], wherein the polyimide-based resin includes an aromatic ring.

[5] The temperature sensor element according to any of [1] to [4], wherein a content of the matrix resin is 10% by mass or more and 90% by mass or less based on a mass of the temperature-sensitive film of 100% by mass.

### Advantageous Effect of Invention

There can be provided a temperature sensor element that is improved in accuracy of temperature measurement and in durability over time of a temperature-sensitive film.

The present invention can provide a temperature sensor element that can detect a slight amount of change in temperature, for example, 0.1° C. or less, and that is excellent in accuracy of temperature measurement.

### BRIEF DESCRIPTION OF DRAWINGS

FIG. 1 is a schematic top view illustrating one example of the temperature sensor element according to the present invention.

FIG. 2 is a schematic cross-sectional view illustrating one example of the temperature sensor element according to the present invention.

FIG. 3 is a schematic top view illustrating a method of producing a temperature sensor element of Example 1.

FIG. 4 is a schematic top view illustrating the method of producing the temperature sensor element of Example 1.

FIG. 5 is a SEM photograph of a temperature-sensitive film included in the temperature sensor element of Example 2.

### DESCRIPTION OF EMBODIMENTS

The temperature sensor element according to the present invention (hereinafter, also simply referred to as “temperature sensor element”) includes a pair of electrodes and a temperature-sensitive film disposed in contact with the pair of electrodes.

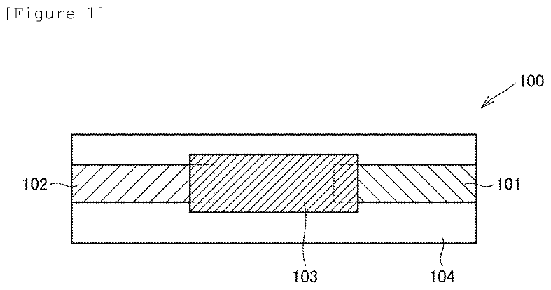

FIG. 1 is a schematic top view illustrating one example of the temperature sensor element. A temperature sensor element 100 illustrated in FIG. 1 includes a pair of electrodes of a first electrode 101 and a second electrode 102, and a temperature-sensitive film 103 disposed in contact with both the first electrode 101 and the second electrode 102. The temperature-sensitive film 103, both ends of which are formed on the first electrode 101 and the second electrode 102, respectively, is thus in contact with such electrodes.

The temperature sensor element can further include a substrate 104 that supports the first electrode 101, the second electrode 102 and the temperature-sensitive film 103 (see FIG. 1).

The temperature sensor element 100 illustrated in FIG. 1 is a thermistor-type temperature sensor element where the temperature-sensitive film 103 detects the change in temperature, as an electric resistance value.

The temperature-sensitive film 103 has NTC characteristics that exhibit a decrease in electric resistance value due to the rise in temperature.

[1] First Electrode and Second Electrode

The first electrode 101 and the second electrode 102 here used are sufficiently small in electric resistance value as compared with the temperature-sensitive film 103.

The respective electric resistance values of the first electrode 101 and the second electrode 102 included in the temperature sensor element are specifically preferably 500Ω or less, more preferably 200Ω or less, further preferably 100Ω or less at a temperature of 25° C.

The respective materials of the first electrode 101 and the second electrode 102 are not particularly limited as long as a sufficiently small electric resistance value is obtained as compared with that of the temperature-sensitive film 103, and such each material can be, for example, a metal single substance such as gold, silver, copper, platinum, or palladium; an alloy including two or more metal materials; a metal oxide such as indium tin oxide (ITO) or indium zinc oxide (IZO); or a conductive organic substance (for example, a conductive polymer).

The material of the first electrode 101 and the material of the second electrode 102 may be the same as or different from each other.

The respective methods of forming the first electrode 101 and the second electrode 102 are not particularly limited, and may be each a common method such as vapor deposition, sputtering, or coating (coating method). The first electrode 101 and the second electrode 102 can be each formed directly on the substrate 104.

The respective thicknesses of the first electrode 101 and the second electrode 102 are not particularly limited as long as a sufficiently small electric resistance value is obtained as compared with that of the temperature-sensitive film 103, and such each thickness is, for example, 50 nm or more and 1000 nm or less, preferably 100 nm or more and 500 nm or less.

[2] Substrate

The substrate 104 is a support that supports the first electrode 101, the second electrode 102 and the temperature-sensitive film 103.

The material of the substrate 104 is not particularly limited as long as the material is non-conductive (insulating), and the material can be, for example, a resin material such as a thermoplastic resin or an inorganic material such as glass. In a case where a resin material is used in the substrate 104, the temperature-sensitive film 103 typically has flexibility and thus flexibility can be imparted to the temperature sensor element.

The thickness of the substrate 104 is preferably set in consideration of flexibility, durability, and the like of the temperature sensor element. The thickness of the substrate 104 is, for example, 10 μm or more and 5000 μm or less, preferably 50 μm or more and 1000 μm or less.

[3] Temperature-Sensitive Film

The temperature-sensitive film 103 includes a conjugated polymer and a matrix resin. The temperature-sensitive film 103 preferably further includes a dopant. The conjugated polymer and the dopant in the temperature-sensitive film 103 preferably form a conjugated polymer doped with the dopant, namely, a conductive polymer.

A conjugated polymer by itself is usually extremely low in electric conductivity, and exhibits almost no electric conducting properties, for example, which correspond to 1×10⁻⁶ S/m or less. The reason why a conjugated polymer by itself is low in electric conductivity is because the valance band is saturated with electrons and such electrons cannot be freely transferred. On the other hand, a conjugated polymer, in which electrons are delocalized, is thus remarkably low in ionization potential and very large in electron affinity as compared with a saturated polymer. Accordingly, a conjugated polymer easily allows charge transfer with an appropriate dopant such as an electron acceptor (acceptor) or an electron donor (donor) to occur, and such a dopant can withdraw an electron from the valance band of such a conjugated polymer or inject an electron to the conduction band thereof. Thus, such a conjugated polymer doped with a dopant, namely, the conductive polymer can have a few holes present in the valance band or a few electrons present in the conduction band to allow such holes and/or electrons to be freely transferred, and thus tends to be drastically enhanced in conductive properties.

[3-1] Conductive Polymer

The conductive polymer, which is a single substance, preferably has a value of linear resistance R in the range of 0.01Ω or more and 300 MΩ or less at a temperature of 25° C., as measured with an electric tester at a distance between lead bars of several mm to several cm.

The conjugated polymer constituting the conductive polymer is one having a conjugated structure in its molecule, and examples include a polymer having a backbone where a double bond and a single bond are alternately linked, and a polymer having an unshared pair of electrons conjugated.

Such a conjugated polymer can easily impart electric conducting properties by doping, as described above.

The conjugated polymer is not particularly limited, and examples thereof include polyacetylene; poly(p-phenylenevinylene); polypyrrole; polythiophene-based polymers such as poly(3,4-ethylenedioxythiophene) [PEDOT]; and polyaniline-based polymers (for example, polyaniline, and polyaniline having a substituent). The polythiophene-based polymer here means, for example, polythiophene, a polymer having a polythiophene backbone and having a side chain into which a substituent is introduced, and a polythiophene derivative. The “-based polymer” mentioned herein means a similar molecule.

The conjugated polymer may be used singly or in combinations of two or more kinds thereof.

In the present invention, the conjugated polymer is preferably a polyaniline-based polymer from the viewpoint of easiness of polymerization and identification.

Examples of the dopant include a compound serving as an electron acceptor (acceptor) from the conjugated polymer and a compound serving as an electron donor (donor) to the conjugated polymer.

The dopant serving as an electron acceptor is not particularly limited, and examples thereof include halogen such as Cl₂, Br₂, I₂, ICl, ICl₃, IBr, and IF₃; Lewis acids such as PFs, AsF₅, SbF₅, BF₃, and SO₃; proton acids such as HCl, H₂SO₄, and HClO₄; transition metal halides such as FeCl₃, FeBr₃, and SnCl₄; and organic compounds such as tetracyanoethylene (TCNE), tetracyanoquinodimethane (TCNQ), 2,3-dichloro-5,6-dicyano-p-benzoquinone (DDQ), amino acids, polystyrenesulfonic acid, p-toluenesulfonic acid, and camphorsulfonic acid.

The dopant serving as an electron donor is not particularly limited, and examples thereof include alkali metals such as Li, Na, K, Rb, and Cs; alkali earth metals such as Be, Mg, Ca, Sc, Ba, Ag, Eu, and Yb, or other metals.

The dopant is preferably selected appropriately depending on the type of the conjugated polymer.

The dopant may be used singly or in combinations of two or more kinds thereof.

The content of the dopant in the temperature-sensitive film 103 is preferably 0.1 mol or more, more preferably 0.4 mol or more based on 1 mol of the conjugated polymer, from the viewpoint of conductive properties of the conductive polymer. The content is preferably 3 mol or less, more preferably 2 mol or less based on 1 mol of the conjugated polymer.

The content of the dopant in the temperature-sensitive film 103 is preferably 1% by mass or more, more preferably 3% by mass or more based on the mass of the temperature-sensitive film of 100% by mass. The content is preferably 60% by mass or less, more preferably 50% by mass or less.

The electric conductivity of the conductive polymer is obtained by combining the electronic conductivity in a molecular chain, the electronic conductivity between molecular chains, and the electronic conductivity between fibrils.

Carrier transfer is generally described by a hopping conduction mechanism. An electron present at a localized level in a non-crystalline region can be jumped to an adjacent localized level by the tunneling effect, in a case where the distance between localized states is short. In a case where there is a difference in energy between localized states, a thermal excitation process depending on the difference in energy is required. The conduction due to tunneling with such a thermal excitation process corresponds to hopping conduction.

In a case where the density of states is high at a low temperature or in the vicinity of the Fermi level, hopping to a distal level, small in difference in energy, is more dominant than hopping to a proximal level, large in difference in energy. In such a case, a variable range hopping conduction model (Mott-VRFH model) is applied, and the temperature dependence of the electric resistance value p of the conductive polymer is represented by the following expression.

ρ=ρ₀ exp(T₀/T)^{α}

In the expression, T₀=16/[k_{B}l_{∥}l_{⊥}²N(E_{F})] is satisfied, k_{B} represents the Boltzmann constant, l_{∥} and l_{⊥} each represent the localization length of the wave function, N(E_{F}) represents the electronic density of states at the Fermi level E_{F}, ρ₀ represents the constant number, T represents the temperature (K), α represents 1/(n+1), and n represents the number of dimensions of hopping. Hopping in the conductive polymer and hopping between the conductive domains are each three-dimensional hopping, and in such a case, α is ¼.

As can also be understood from the expression, the conductive polymer has NTC characteristics that exhibit a decrease in electric resistance value due to the rise in temperature.

[3-2] Matrix Resin

The temperature-sensitive film 103 preferably includes a matrix resin and a conductive polymer, more preferably includes a matrix resin and a plurality of conductive domains that are dispersed in the matrix resin and that include a conductive polymer. The matrix resin included in the temperature-sensitive film 103 is preferably a matrix that allows the conductive polymer (namely, conjugated polymer doped with a dopant) to be dispersed in and fixed to the temperature-sensitive film 103.

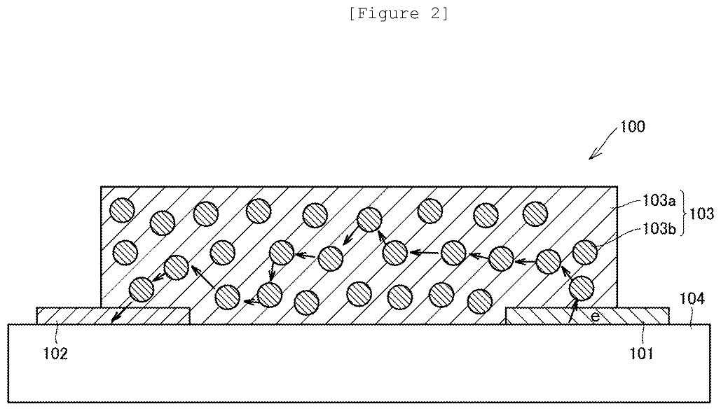

FIG. 2 is a schematic cross-sectional view illustrating one example of the temperature sensor element. A temperature sensor element 100 illustrated in FIG. 2 includes a temperature-sensitive film 103 including a matrix resin 103a and a plurality of conductive domains 103b dispersed in the matrix resin 103a. The conductive domains 103b include a conjugated polymer and a dopant, and are preferably constituted by a conductive polymer.

The conductive domains 103b refer to a plurality of regions in the temperature-sensitive film 103 included in the temperature sensor element, which are dispersed in the matrix resin 103a and which contribute to electron transfer.

The plurality of conductive domains 103b including the conductive polymer can be dispersed in the matrix resin 103a, thereby allowing the distance between the conductive domains to be increased to some extent. Thus, the electric resistance detected by the temperature sensor element can be any electric resistance mainly derived from hopping conduction (electron transfer indicated by an arrow in FIG. 2) between the conductive domains. Such hopping conduction is highly dependent on the temperature, as represented by the above expression. Accordingly, such hopping conduction can be dominant to result in an enhancement in temperature dependence of the electric resistance value exhibited by the temperature-sensitive film 103.

The plurality of conductive domains 103b including the conductive polymer are dispersed in the matrix resin 103a, resulting in a tendency to obtain a temperature sensor element that hardly causes defects such as cracks to occur in the temperature-sensitive film 103 in use of the temperature sensor element and that has such a temperature-sensitive film 103 excellent in stability over time.

Examples of the matrix resin 103a include a cured product of an active energy ray-curable resin, a cured product of a thermosetting resin, and a thermoplastic resin. In particular, a thermoplastic resin is preferably used.

The thermoplastic resin is not particularly limited, and examples thereof include polyolefin-based resins such as polyethylene and polypropylene; polyester-based resins such as polyethylene terephthalate; polycarbonate-based resins; (meth)acrylic resins; cellulose-based resins; polystyrene-based resins; polyvinyl chloride-based resins; acrylonitrile-butadiene-styrene-based resins; acrylonitrile-styrene-based resins; polyvinyl acetate-based resins; polyvinylidene chloride-based resins; polyamide-based resins; polyacetal-based resins; modified polyphenylene ether-based resins; polysulfone-based resins; polyethersulfone-based resins; polyarylate-based resins; and polyimide-based resins such as polyimide and polyamideimide.

The matrix resin 103a may be used singly or in combinations of two or more kinds thereof.

In particular, the matrix resin 103a is preferably high in polymer packing properties (also referred to as “molecular packing properties”). Such a matrix resin 103a high in molecular packing properties is used to thereby enable penetration of moisture into the temperature-sensitive film 103 to be effectively suppressed. Such suppression of penetration of moisture into the temperature-sensitive film 103 can also contribute to suppression of deterioration in measurement accuracy as indicated in the following 1) and 2).

1) If moisture is diffused in the temperature-sensitive film 103, an ion channel with water tends to be formed to result in an increase in electric conductivity due to ion conduction or the like. Such an increase in electric conductivity due to ion conduction or the like can cause a thermistor-type temperature sensor element that detects the change in temperature, as the electric resistance value, to be deteriorated in measurement accuracy.

2) If moisture is diffused in the temperature-sensitive film 103, the matrix resin 103a tends to be swollen to result in an increase in distance between the conductive domains 103b. This can lead to an increase in electric resistance value detected by the temperature sensor element, resulting in deterioration in measurement accuracy.

Such molecular packing properties are based on intermolecular interaction. Accordingly, one solution to enhance molecular packing properties of the matrix resin 103a is to introduce a functional group or moiety that easily results in intermolecular interaction, into a polymer chain.

Examples of the functional group or moiety include functional groups each capable of forming a hydrogen bond, such as a hydroxyl group, a carboxyl group, and an amino group, and functional groups or moieties (for example, moieties such as an aromatic ring) each capable of allowing π-π stacking interaction to occur.

In particular, in a case where a polymer capable of allowing π-π stacking interaction to occur is used in the matrix resin 103a, packing due to π-π stacking interaction is easily uniformly extended to the entire molecule and thus penetration of moisture into the temperature-sensitive film 103 can be more effectively suppressed.

In a case where a polymer capable of allowing π-π stacking interaction to occur is used in the matrix resin 103a, a moiety allowing intermolecular interaction to occur is hydrophobic and thus penetration of moisture into the temperature-sensitive film 103 can be more effectively suppressed.

A crystalline resin and a liquid crystalline resin also each have a highly ordered structure, and thus are each suitable as the matrix resin 103a high in molecular packing properties.

One resin preferably used as the matrix resin 103a is a polyimide-based resin from the viewpoint of heat resistance of the temperature-sensitive film 103, film formability of the temperature-sensitive film 103, and the like. Such a polyimide-based resin preferably includes an aromatic ring and more preferably includes an aromatic ring in a main chain because π-π stacking interaction easily occurs.

The polyimide-based resin can be obtained by, for example, reacting a diamine and a tetracarboxylic acid, or reacting an acid chloride in addition to them. The diamine and the tetracarboxylic acid here also include respective derivatives. The “diamine” simply designated herein means any diamine and any derivative thereof, and the “tetracarboxylic acid” simply designated herein also means any derivative thereof again.

The diamine and the tetracarboxylic acid may be each used singly or in combinations of two or more kinds thereof.

Examples of the diamine include diamine and diaminodisilane, and preferably diamine.

Examples of the diamine include an aromatic diamine, an aliphatic diamine, or a mixture thereof, and preferably include an aromatic diamine. The aromatic diamine can be used to provide a polyimide-based resin where π-π stacking can be made.

The aromatic diamine refers to a diamine where an amino group is directly bound to an aromatic ring, and the structure thereof may partially include an aliphatic group, an alicyclic group or other substituent. The aliphatic diamine refers to a diamine where an amino group is directly bound to an aliphatic group or an alicyclic group, and the structure thereof may partially include an aromatic group or other substituent.

An aliphatic diamine having an aromatic group in a portion of the structure can also be used to provide a polyimide-based resin where π-π stacking can be made.

Examples of the aromatic diamine include phenylenediamine, diaminotoluene, diaminobiphenyl, bis(aminophenoxy)biphenyl, diaminonaphthalene, diaminodiphenyl ether, bis[(aminophenoxy)phenyl]ether, diaminodiphenyl sulfide, bis[(aminophenoxy)phenyl]sulfide, diaminodiphenyl sulfone, bis[(aminophenoxy)phenyl]sulfone, diaminobenzophenone, diaminodiphenylmethane, bis[(aminophenoxy)phenyl]methane, bisaminophenylpropane, bis[(aminophenoxy)phenyl]propane, bisaminophenoxybenzene, bis[(“amino-α,α′-dimethylbenzyl)]benzene, bisaminophenyldiisopropylbenzene, bisaminophenylfluorene, bisaminophenylcyclopentane, bisaminophenylcyclohexane, bisaminophenylnorbornane, bisaminophenyladamantane, and such any compound where one or more hydrogen atoms of the compound are each replaced with a fluorine atom or a hydrocarbon group including a fluorine atom (trifluoromethyl group or the like).

The aromatic diamine may be used singly or in combinations of two or more kinds thereof.

Examples of the phenylenediamine include m-phenylenediamine and p-phenylenediamine.

Examples of the diaminotoluene include 2,4-diaminotoluene and 2,6-diaminotoluene.

Examples of the diaminobiphenyl include benzidine (another name: 4,4′-diaminobiphenyl), o-tolidine, m-tolidine, 3,3′-dihydroxy-4,4′-diaminobiphenyl, 2,2-bis(3-amino-4-hydroxyphenyl)propane (BAPA), 3,3′-dimethoxy-4,4′-diaminobiphenyl, 3,3′-dichloro-4,4′-diaminobiphenyl, 2,2′-dimethyl-4,4′-diaminobiphenyl, and 3,3′-dimethyl-4,4′-diaminobiphenyl.

Examples of the bis(aminophenoxy)biphenyl include 4,4′-bis(4-aminophenoxy)biphenyl (BAPB), 3,3′-bis(4-aminophenoxy)biphenyl, 3,4′-bis(3-aminophenoxy)biphenyl, 4,4′-bis(2-methyl-4-aminophenoxy)biphenyl, 4,4′-bis(2,6-dimethyl-4-aminophenoxy)biphenyl, and 4,4′-bis(3-aminophenoxy)biphenyl.

Examples of the diaminonaphthalene include 2,6-diaminonaphthalene and 1,5-diaminonaphthalene.

Examples of the diaminodiphenyl ether include 3,4′-diaminodiphenyl ether and 4,4′-diaminodiphenyl ether.

Examples of the bis[(aminophenoxy)phenyl]ether include bis[4-(3-aminophenoxy)phenyl]ether, bis[4-(4-aminophenoxy)phenyl]ether, bis[3-(3-aminophenoxy)phenyl]ether, bis(4-(2-methyl-4-aminophenoxy)phenyl)ether, and bis(4-(2,6-dimethyl-4-aminophenoxy)phenyl)ether.

Examples of the diaminodiphenyl sulfide include 3,3′-diaminodiphenyl sulfide, 3,4′-diaminodiphenyl sulfide, and 4,4′-diaminodiphenyl sulfide.

Examples of the bis[(aminophenoxy)phenyl]sulfide include bis[4-(4-aminophenoxy)phenyl]sulfide, bis[3-(4-aminophenoxy)phenyl]sulfide, bis[4-(3-aminophenoxy)phenyl]sulfide, bis[3-(4-aminophenoxy)phenyl]sulfide, and bis[3-(3-aminophenoxy)phenyl]sulfide.

Examples of the diaminodiphenyl sulfone include 3,3′-diaminodiphenyl sulfone, 3,4′-diaminodiphenyl sulfone, and 4,4′-diaminodiphenyl sulfone.

Examples of the bis[(aminophenoxy)phenyl]sulfone include bis[3-(4-aminophenoxy)phenyl]sulfone, bis[4-(4-aminophenyl)]sulfone, bis[3-(3-aminophenoxy)phenyl]sulfone, bis[4-(3-aminophenyl)]sulfone, bis[4-(4-aminophenoxy)phenyl]sulfone, bis[4-(2-methyl-4-aminophenoxy)phenyl]sulfone, and bis[4-(2,6-dimethyl-4-aminophenoxy)phenyl]sulfone.

Examples of the diaminobenzophenone include 3,3′-diaminobenzophenone and 4,4′-diaminobenzophenone.

Examples of the diaminodiphenylmethane include 3,3′-diaminodiphenylmethane, 3,4′-diaminodiphenylmethane, and 4,4′-diaminodiphenylmethane.

Examples of the bis[(aminophenoxy)phenyl]methane include bis[4-(3-aminophenoxy)phenyl]methane, bis[4-(4-aminophenoxy)phenyl]methane, bis[3-(3-aminophenoxy)phenyl]methane, and bis[3-(4-aminophenoxy)phenyl]methane.

Examples of the bisaminophenylpropane include 2,2-bis(4-aminophenyl)propane, 2,2-bis(3-aminophenyl)propane, 2-(3-aminophenyl)-2-(4-aminophenyl)propane, 2,2-bis(2-methyl-4-aminophenyl)propane, and 2,2-bis(2,6-dimethyl-4-aminophenyl)propane.

Examples of the bis[(aminophenoxy)phenyl]propane include 2,2-bis[4-(2-methyl-4-aminophenoxy)phenyl]propane, 2,2-bis[4-(2,6-dimethyl-4-aminophenoxy)phenyl]propane, 2,2-bis[4-(3-aminophenoxy)phenyl]propane, 2,2-bis[4-(4-aminophenoxy)phenyl]propane, 2,2-bis[3-(3-aminophenoxy)phenyl]propane, and 2,2-bis[3-(4-aminophenoxy)phenyl]propane.

Examples of the bisaminophenoxybenzene include 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,4-bis(2-methyl-4-aminophenoxy)benzene, 1,4-bis(2,6-dimethyl-4-aminophenoxy)benzene, 1,3-bis(2-methyl-4-aminophenoxy)benzene, and 1,3-bis(2,6-dimethyl-4-aminophenoxy)benzene.

Examples of the bis(amino-α,α′-dimethylbenzyl)benzene (another name: bisaminophenyldiisopropylbenzene) include 1,4-bis(4-amino-α,α′-dimethylbenzyl)benzene (BiSAP, another name: α,α′-bis(4-aminophenyl)-1,4-diisopropylbenzene), 1,3-bis[4-(4-amino-6-methylphenoxy)-α,α′-dimethylbenzyl]benzene, α,α′-bis(2-methyl-4-aminophenyl)-1,4-diisopropylbenzene, α,α′-bis(2,6-dimethyl-4-aminophenyl)-1,4-diisopropylbenzene, α,α′-bis(3-aminophenyl)-1,4-diisopropylbenzene, α,α′-bis(4-aminophenyl)-1,3-diisopropylbenzene, α,α′-bis(2-methyl-4-aminophenyl)-1,3-diisopropylbenzene, α,α′-bis(2,6-dimethyl-4-aminophenyl)-1,3-diisopropylbenzene, and α,α′-bis(3-aminophenyl)-1,3-diisopropylbenzene.

Examples of the bisaminophenyl fluorene include 9,9-bis(4-aminophenyl)fluorene, 9,9-bis(2-methyl-4-aminophenyl)fluorene, and 9,9-bis(2,6-dimethyl-4-aminophenyl)fluorene.

Examples of the bisaminophenylcyclopentane include 1,1-bis(4-aminophenyl)cyclopentane, 1,1-bis(2-methyl-4-aminophenyl)cyclopentane, and 1,1-bis(2,6-dimethyl-4-aminophenyl)cyclopentane.

Examples of the bisaminophenylcyclohexane include 1,1-bis(4-aminophenyl)cyclohexane, 1,1-bis(2-methyl-4-aminophenyl)cyclohexane, 1,1-bis(2,6-dimethyl-4-aminophenyl)cyclohexane, and 1,1-bis(4-aminophenyl)4-methyl-cyclohexane.

Examples of the bisaminophenylnorbornane include 1,1-bis(4-aminophenyl)norbornane, 1,1-bis(2-methyl-4-aminophenyl)norbornane, and 1,1-bis(2,6-dimethyl-4-aminophenyl)norbornane.

Examples of the bisaminophenyladamantane include 1,1-bis(4-aminophenyl)adamantane, 1,1-bis(2-methyl-4-aminophenyl)adamantane, and 1,1-bis(2,6-dimethyl-4-aminophenyl)adamantane.

Examples of the aliphatic diamine include ethylenediamine, hexamethylenediamine, polyethylene glycol bis(3-aminopropyl)ether, polypropylene glycol bis(3-aminopropyl)ether, 1,3-bis(aminomethyl)cyclohexane, 1,4-bis(aminomethyl)cyclohexane, m-xylylenediamine, p-xylylenediamine, 1,4-bis(2-amino-isopropyl)benzene, 1,3-bis(2-amino-isopropyl)benzene, isophoronediamine, norbornanediamine, siloxanediamines, and such any compound where one or more hydrogen atoms of the compound are each replaced with a fluorine atom or a hydrocarbon group including a fluorine atom (trifluoromethyl group or the like).

The aliphatic diamine may be used singly or in combinations of two or more kinds thereof.

Examples of the tetracarboxylic acid include tetracarboxylic acid, tetracarboxylic acid esters, and tetracarboxylic dianhydride, and preferably include tetracarboxylic dianhydride.

Examples of the tetracarboxylic dianhydride include tetracarboxylic dianhydrides such as pyromellitic dianhydride, 3,3′,4,4′-benzophenonetetracarboxylic dianhydride, 1,4-hydroquinonedibenzoate-3,3′,4,4′-tetracarboxylic dianhydride, 3,3′,4,4′-biphenyltetracarboxylic dianhydride, 3,3′,4,4′-diphenyl ether tetracarboxylic dianhydride (ODPA), 1,2,4,5-cyclohexanetetracarboxylic dianhydride (HPMDA), 1,2,3,4-cyclobutanetetracarboxylic dianhydride, 1,2,4,5-cyclopentanetetracarboxylic dianhydride, bicyclo[2,2,2]oct-7-ene-2,3,5,6-tetracarboxylic dianhydride, 2,3,3′,4′-biphenyltetracarboxylic dianhydride, 3,3′,4,4′-benzophenonetetracarboxylic dianhydride, 4,4-(p-phenylenedioxy)diphthalic dianhydride, and 4,4-(m-phenylenedioxy)diphthalic dianhydride; 2,2-bis(3,4-dicarboxyphenyl)propane, 2,2-bis(2,3-dicarboxyphenyl)propane, bis(3,4-dicarboxyphenyl)sulfone, bis(3,4-dicarboxyphenyl)ether, bis(2,3-dicarboxyphenyl)ether, 1,1-bis(2,3-dicarboxyphenyl)ethane, bis(2,3-dicarboxyphenyl)methane, and bis(3,4-dicarboxyphenyl)methane; and

such any compound where one or more hydrogen atoms of the compound are each replaced with a fluorine atom or a hydrocarbon group including a fluorine atom (trifluoromethyl group or the like).

The tetracarboxylic dianhydride may be used singly or in combinations of two or more kinds thereof.

Examples of the acid chloride include respective acid chlorides of a tetracarboxylic acid compound, a tricarboxylic acid compound, and a dicarboxylic acid compound, and in particular, an acid chloride of a dicarboxylic acid compound is preferably used. Examples of the acid chloride of a dicarboxylic acid compound include 4,4′-oxybis(benzoyl chloride) [OBBC] and terephthaloyl dichloride (TPC).

In a case where the matrix resin 103a includes a fluorine atom, penetration of moisture into the temperature-sensitive film 103 tends to be capable of being more effectively suppressed. A polyimide-based resin including a fluorine atom can be prepared by using one where at least any one of a diamine and a tetracarboxylic acid for use in preparation includes a fluorine atom.

One example of such a diamine including a fluorine atom is 2,2′-bis(trifluoromethyl)benzidine (TFMB). One example of such a tetracarboxylic acid including a fluorine atom is 4,4′-(1,1,1,3,3,3-hexafluoropropane-2,2-diyl)diphthalic dianhydride (6FDA).

The weight average molecular weight of the polyimide-based resin is preferably 20000 or more, more preferably 50000 or more, and preferably 1000000 or less, more preferably 500000 or less.

The weight average molecular weight can be determined with a size exclusion chromatography apparatus.

The matrix resin 103a preferably includes 50% by mass or more, more preferably 70% by mass or more, further preferably 90% by mass or more, still further preferably 95% by mass or more, particularly preferably 100% by mass of the polyimide-based resin, based on the total of the resin component(s) of 100% by mass constituting the matrix resin. The polyimide-based resin is preferably a polyimide-based resin including an aromatic ring, more preferably, a polyimide-based resin including an aromatic ring and a fluorine atom.

On the other hand, the matrix resin 103a preferably has the property of easily forming a film from the viewpoint of film formability. In one example thereof, the matrix resin 103a is preferably a soluble resin excellent in wet film formability. A resin structure imparting the property is, for example, one having a properly bent structure in a main chain, and such a structure is obtained by, for example, a method involving allowing the main chain to contain an ether bond to thereby impart a bent structure, and a method involving introducing a substituent such as an alkyl group into the main chain to thereby impart a bent structure based on the steric hindrance.

[3-3] Configuration of Temperature-Sensitive Film

The temperature-sensitive film 103 preferably has a configuration that includes the matrix resin 103a and the plurality of conductive domains 103b dispersed in the matrix resin 103a. The conductive domains 103b are preferably constituted by a conductive polymer (conjugated polymer doped with a dopant).

According to the above configuration, such hopping conduction can be dominant to result in an enhancement in temperature dependence of the electric resistance value exhibited by the temperature-sensitive film 103.

The temperature-sensitive film 103 includes the matrix resin 103a and the plurality of conductive domains 103b dispersed in the matrix resin 103a, resulting in a tendency to elongate the distance of hopping. The distance of hopping is elongated to result in an increase in resistance value, and thus the amount of change in electric resistance value detected is mainly derived from hopping conduction. Thus, the amount of change in electric resistance value per unit temperature exhibited by the temperature-sensitive film 103 can be increased, resulting in an increase in accuracy of temperature measurement of the temperature sensor element.

The content of the matrix resin 103a is preferably 10% by mass or more, more preferably 15% by mass or more, further preferably 30% by mass or more, still further preferably 40′% by mass or more, particularly preferably 50% by mass or more based on the mass of the temperature-sensitive film 103 of 100% by mass, from the viewpoint of an increase in accuracy of temperature measurement.

In a case where the temperature-sensitive film 103 includes no matrix resin 103a, the conductive domains 103b are hardly dispersed as compared with a case where the matrix resin 103a is included, resulting in a tendency to decrease the amount of change in electric resistance value per unit temperature exhibited by the temperature-sensitive film 103. The reason for this is because a low dispersibility easily allows any conduction other than hopping conduction to occur in the temperature-sensitive film 103 and/or easily allows hopping conduction to occur between any short-distance conductive domains 103b. A decreased amount of change in electric resistance value per unit temperature exhibited by the temperature-sensitive film 103 leads to an increased amount of change in temperature, which can be detected upon the change of a predetermined amount of electric resistance, resulting in a tendency to deteriorate the accuracy of temperature measurement.

Furthermore, in a case where the temperature-sensitive film 103 includes no matrix resin 103a, cracking easily occurs in the temperature-sensitive film 103 in use of the temperature sensor element, and the stability over time of the temperature-sensitive film 103 tends to be inferior.

The content of the matrix resin 103a in the temperature-sensitive film 103 is preferably 90% by mass or less, more preferably 80% by mass or less, further preferably 70% by mass or less based on the mass of the temperature-sensitive film 103 of 100% by mass, from the viewpoint of a reduction in power consumption of the temperature sensor element and from the viewpoint of a normal operation of the temperature sensor element.

A high content of the matrix resin 103a results in a tendency to increase the electric resistance, sometimes leading to an increase in current necessary for measurement and thus a remarkable increase in power consumption. A high content of the matrix resin 103a also sometimes provides no communication between the electrodes. A high content of the matrix resin 103a sometimes causes Joule heat to be generated depending on the current flowing, and also sometimes makes temperature measurement by itself difficult.

The content of the matrix resin 103a in the polymer composition for a temperature-sensitive film, based on the solid component of 100% by mass in the composition, is in the same range as the content range based on the mass of the temperature-sensitive film of 100% by mass.

The thickness of the temperature-sensitive film 103 is not particularly limited, and is, for example, 0.3 μm or more and 50 μm or less. The thickness of the temperature-sensitive film 103 is preferably 0.3 μm or more and 40 μm or less from the viewpoint of flexibility of the temperature sensor element.

[3-4] Production of Temperature-Sensitive Film

The temperature-sensitive film 103 is obtained by stirring and mixing the conjugated polymer, the matrix resin (for example, thermoplastic resin), the dopant, if necessary, used, and a solvent to thereby prepare a polymer composition for a temperature-sensitive film, and forming the composition into a film. Examples of the film formation method include a method involving applying the polymer composition for a temperature-sensitive film onto the substrate 104, and then drying and, if necessary, heat-treating the resultant. The method of applying the polymer composition for a temperature-sensitive film is not particularly limited, and examples include a spin coating method, a screen printing method, an ink-jet printing method, a dip coating method, an air knife coating method, a roll coating method, a gravure coating method, a blade coating method, and a dropping method.

In a case where the matrix resin 103a is formed from an active energy ray-curable resin or a thermosetting resin, a curing treatment is further applied. In a case where an active energy ray-curable resin or a thermosetting resin is used, no solvent may be required to be added to the polymer composition for a temperature-sensitive film, and in this case, no drying treatment is also required.

In a case where the dopant is used, the polymer composition for a temperature-sensitive film usually allows the conjugated polymer and the dopant to form conductive polymer domains (conductive domains) and such domains are dispersed in the composition.

In a case where the polymer composition for a temperature-sensitive film includes the matrix resin, the conductive domains are further dispersed in the composition as compared with a case where no matrix resin is included. Thus, the electric resistance detected by the temperature sensor element is mainly derived from hopping conduction between the conductive domains, as described above, and the temperature sensor element can more reliably detect the amount of change in electric resistance value.

The content of the matrix resin in the polymer composition (excluding the solvent) for a temperature-sensitive film is preferably substantially the same as the content of the matrix resin in the temperature-sensitive film 103 formed from the composition. The content of each component included in the polymer composition for a temperature-sensitive film corresponds to the content of each component relative to the total of each component in the polymer composition for a temperature-sensitive film, excluding the solvent, and is preferably substantially the same as the content of each component in the temperature-sensitive film 103 formed from the polymer composition for a temperature-sensitive film.

The solvent included in the polymer composition for a temperature-sensitive film is preferably a solvent that can dissolve the conjugated polymer, the dopant and the matrix resin, from the viewpoint of film formability.

The solvent is preferably selected depending on, for example, the solubilities in the conjugated polymer, the dopant and the matrix resin used.

Examples of such a usable solvent include N-methyl-2-pyrrolidone, N,N-dimethylacetamide, N,N-diethylacetamide, N,N-dimethylformamide, N,N-diethylformamide, N-methylcaprolactam, N-methylformamide, N,N,2-trimethylpropionamide, hexamethylphosphoramide, tetramethylenesulfone, dimethylsulfoxide, m-cresol, phenol, p-chlorophenol, 2-chloro-4-hydroxytoluene, diglyme, triglyme, tetraglyme, dioxane, γ-butyrolactone, dioxolane, cyclohexanone, cyclopentanone, 1,4-dioxane, ε-caprolactam, dichloromethane, and chloroform.

The solvent may be used singly or in combinations of two or more kinds thereof.

The polymer composition for a temperature-sensitive film may include one or more additives such as an antioxidant, a flame retardant, a plasticizer, and an ultraviolet absorber.

The total content of the conjugated polymer, the dopant and the matrix resin in the polymer composition for a temperature-sensitive film is preferably 90% by mass or more based on the solid content (all components other than the solvent) of the polymer composition for a temperature-sensitive film, of 100% by mass. The total content is more preferably 95% by mass or more, further preferably 98% by mass or more, and may be 100% by mass.

[4] Temperature Sensor Element

The temperature sensor element can include any constituent component other than the above constituent components. Examples of such other constituent component include those commonly used for temperature sensor elements, such as an electrode, an insulation layer, and a sealing layer that seals the temperature-sensitive film.

The temperature sensor element including the temperature-sensitive film is excellent in accuracy of temperature measurement, and can detect a change in temperature of, for example, even 0.1° C. or less. The temperature sensor element includes a temperature-sensitive film improved in durability over time.

The accuracy of temperature measurement can be evaluated according to the following method. First, the electric resistance value per unit temperature is calculated. Next, this numerical value, and the electric resistance value Rₓ that can be detected by the temperature sensor element are plugged in a predetermined expression. Thus, the electric resistance value per unit temperature is converted into the temperature, and the measurement temperature of the temperature sensor element, changed upon the change of a predetermined electric resistance value by Rₓ, is calculated. The electric resistance value Rₓ may be a desired numerical value that can be detected by the temperature sensor element.

The electric resistance value d(R/dT) per unit temperature can be calculated according to the following method. First, the respective average electric resistance values at several temperatures are measured by the temperature sensor element. Next, the respective average electric resistance values at temperatures at two points in a desired temperature range, among the resulting average electric resistance values, are plugged in the following expression (1). The following expression (1) serves as an index indicating the temperature dependence of the electric resistance value of the temperature sensor element, and represents the electric resistance value [unit: kΩ/° C.] per unit temperature.

d(R/dT)=(Rₐᵥₑ₁−Rₐᵥₑ₂)/(T₁−T₂) (1)

In the expression (1), Rₐᵥₑ₁ represents the average electric resistance value at a higher temperature T₁ of the above temperatures at two points, and Rₐᵥₑ₂ represents the average electric resistance value at a lower temperature T₂ of the above temperatures at two points.

Such two points in a desired temperature range can be determined within a temperature range in which use of the temperature sensor element is expected. The difference in temperature between such two points can be, for example, about 10° C.

In Examples described below, the pair of Au electrodes of the temperature sensor element and a digital multimeter are connected with a lead wire, the temperature of the temperature sensor element is adjusted by a Peltier temperature controller, and the average electric resistance value is measured at each temperature at eight points at which the temperature is changed in the range from 10 to 80° C. by 10° C. The measurement temperature may be any temperature at a point other than such eight points, but measurement is preferably performed at three or more points at which the temperatures are in a temperature range in which use of the temperature sensor element is expected.

The average electric resistance value at each temperature is calculated as follows. First, the temperature of the temperature sensor element is adjusted to the initial measurement temperature, this temperature is retained for a certain time, and the average with respect to the electric resistance value for such a retention time is measured as the average electric resistance value at the initial measurement temperature. Next, the temperature of the temperature sensor element is sequentially raised to the next measurement temperature, the temperature raised is retained for a certain time in the same manner, and the average with respect to the electric resistance value for such a retention time is measured as the average electric resistance value at the temperature. Such an operation is performed at each temperature in the same manner. In the following Examples, the initial measurement temperature is set to 10° C. and the retention time is set to 0.5 hours. In such Examples, the index indicating the temperature dependence of the electric resistance value of the temperature sensor element is calculated by use of the average electric resistance value Rₐᵥₑ₃₀ at 30° C. and the average electric resistance value Rₐᵥₑ₄₀ at 40° C., among the resulting measurement values.

The accuracy of temperature measurement can be evaluated by using the d(R/dT) calculated above, according to the following method. First, the electric resistance value Rₓ that can be detected by the temperature sensor element is set. Next, such a numerical value is plugged in the following expression (2). The following expression (2) is to calculate the measurement accuracy T_{A} (° C.) of the temperature sensor element. The expression is to convert the d(R/dT) (namely, electric resistance value per unit temperature) into the temperature, and represents the measurement temperature of the temperature sensor element, changed upon the change in electric resistance value by Rₓ.

T_{A}=Rₓ/[d(R/dT)] (2)

The electric resistance value Rₓ that can be detected can be a desired numerical value that can be detected by the temperature sensor element. In Examples described below, the temperature sensor element is expected to detect an electric resistance value of 0.1 kΩ or more. In such a case, for example, it is meant that, when the d(R/dT) is 0.1, the measurement accuracy T_{A} is 1 and the temperature is changed by 1° C. at a change in electric resistance value of 0.1 kΩ. When the d(R/dT) is more than 0.1, for example, the d(R/dT) is 0.2, the T_{A} calculated according to the expression (2) is 0.5. In such a case, the temperature is changed by 0.5° C. at a change in electric resistance value of 0.1 kΩ, namely, the temperature sensor element can detect a change in temperature of less than 1° C., and thus it is meant that the temperature sensor element is higher in accuracy. On the contrary, when the d(R/dT) is less than 0.1, the T_{A} calculated according to the expression (2) is more than 1. In such a case, the temperature is changed by more than 1° C. at a change in electric resistance value of 0.1 kΩ, namely, the temperature sensor element cannot detect a change in temperature of 1° C. or less, and thus it is meant that the temperature sensor element is lower in accuracy.

A lower measurement accuracy T_{A} calculated according to the expression (2) means a higher accuracy of temperature measurement of the temperature sensor element. The T_{A} is preferably 1° C. or less, more preferably 0.5° C. or less, further preferably 0.1° C. or less, depending on the electric resistance value Rₓ that can be detected.

The durability over time of the temperature sensor element can be evaluated by using the temperature sensor element for a certain time and calculating the rate of change in electric resistance value for the usage time.

The evaluation is made by the following method in Examples described below, and may also be made according to any similar method without being limited to the method. First, a Peltier temperature controller is used to keep the temperature of the temperature sensor element at a certain temperature of 80° C., and the electric resistance value R₅ₘᵢₙ after 5 minutes and the electric resistance value R₃ₕ after 3 hours are measured. Next, these numerical values are plugged in the following expression (3), thereby calculating the rate of change ΔR (unit: %) in electric resistance value. As the rate of change ΔR is lower, the temperature-sensitive film exhibits more excellent durability over time.

ΔR=100×|R₃ₕ−R₅ₘᵢₙ|/R₅ₘᵢₙ (3)

The rate of change ΔR is preferably 2 or less, more preferably 1 or less.

### EXAMPLES

Hereinafter, the present invention is further specifically described with reference to Examples, but the present invention is not limited to these Examples at all. In Examples, “%” and “part(s)” representing any content or amount of use are on a mass basis, unless particularly noted.

### Production Example 1: Preparation of Dedoped Polyaniline

A dedoped polyaniline was prepared by preparing and dedoping a polyaniline doped with hydrochloric acid, as shown in the following [1] and [2].

[1] Preparation of Polyaniline Doped with Hydrochloric Acid

A first aqueous solution was prepared by dissolving 5.18 g of aniline hydrochloride (manufactured by Kanto Kagaku) in 50 mL of water. A second aqueous solution was prepared by dissolving 11.42 g of ammonium persulfate (manufactured by Fujifilm Wako Pure Chemical Corporation) in 50 mL of water.

Next, the first aqueous solution was stirred using a magnetic stirrer at 400 rpm for 10 minutes with the temperature being regulated at 35° C., and thereafter, the second aqueous solution was dropped to the first aqueous solution at a dropping speed of 5.3 mL/min under stirring at the same temperature. After the dropping, a reaction was further allowed to occur for 5 hours with a reaction liquid being kept at 35° C., and thus a solid was precipitated in the reaction liquid.

Thereafter, the reaction liquid was filtered by suction with a paper filter (second kind for chemical analysis in JIS P 3801), and the resulting solid was washed with 200 mL of water. Thereafter, the solid was washed with 100 mL of 0.2 M hydrochloric acid and then 200 mL of acetone, and thereafter dried in a vacuum oven, thereby obtaining a polyaniline doped with hydrochloric acid, represented by the following formula (1).

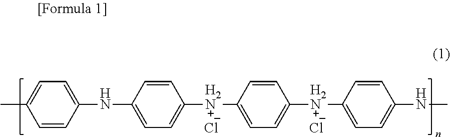

[2] Preparation of Dedoped Polyaniline

Four g of the polyaniline doped with hydrochloric acid, obtained in [1], was dispersed in 100 mL of 12.5% by mass ammonia water and the resultant was stirred with a magnetic stirrer for about 10 hours, thereby precipitating a solid in a reaction liquid.

Thereafter, the reaction liquid was filtered by suction with a paper filter (second kind for chemical analysis in JIS P 3801), and the resulting solid was washed with 200 mL of water and then 200 mL of acetone. Thereafter, the solid was dried in vacuum at 50° C., thereby obtaining a dedoped polyaniline represented by the following formula (2). The dedoped polyaniline was dissolved in N-methylpyrrolidone (NMP; Tokyo Chemical Industry Co., Ltd.) so that the concentration was 5′% by mass, thereby preparing a solution of the dedoped polyaniline (conjugated polymer).

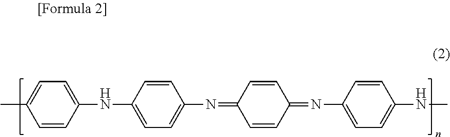

### Production Example 2: Preparation of Matrix Resin 1

A powder of polyimide having a repeating unit represented by the following formula (5) was produced using 2,2′-bis (trifluoromethyl)benzidine (TFMB) represented by the following formula (3), as a diamine, and 4,4′-(1,1,1,3,3,3-hexafluoropropane-2,2-diyl)diphthalic dianhydride (6FDA) represented by the following formula (4), as a tetracarboxylic dianhydride, according to the description in Example 1 of International Publication No. WO 2017/179367.

The powder was dissolved in propylene glycol 1-monomethyl ether 2-acetate so that the concentration was 8% by mass, thereby preparing polyimide solution (1). In the following Examples, polyimide solution (1) was used as matrix resin 1.

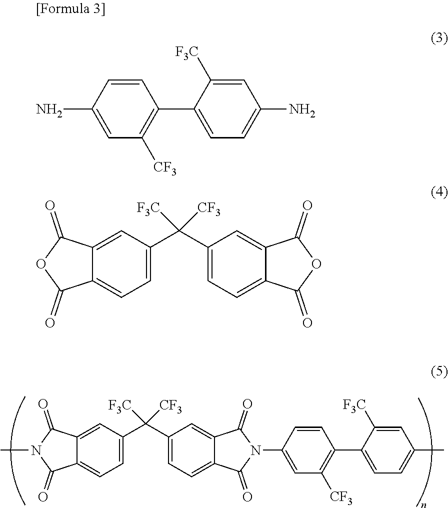

### Production Example 3: Preparation of Matrix Resin 2

Polystyrene (manufactured by Sigma-Aldrich Co. LLC, weight average molecular weight: about 350000, number average molecular weight: about 170000) was dissolved in toluene so that the concentration was 8% by mass, thereby preparing polystyrene solution (1). In the following Examples, polystyrene solution (1) was used as matrix resin 2.

### Production Example 4: Preparation of Matrix Resin 3

Polyvinyl alcohol (manufactured by Sigma-Aldrich Co. LLC, weight average molecular weight: 89000 to 90000) was dissolved in distilled water so that the concentration was 8% by mass, thereby preparing polyvinyl alcohol solution (1). In the following Examples, polyvinyl alcohol solution (1) was used as matrix resin 3.

### Example 1

[1] Preparation of Polymer Composition for Temperature-Sensitive Film

A polymer composition for a temperature-sensitive film was prepared by mixing 0.320 g of the solution of dedoped polyaniline prepared in Production Example 1, 0.784 g of NMP (Tokyo Chemical Industry Co., Ltd.), 0.800 g of polyimide solution (1) as matrix resin 1 prepared in Production Example 2, and 0.016 g of (+)-camphorsulfonic acid (Tokyo Chemical Industry Co., Ltd.) as a dopant. The dopant was used in an amount of 1.6 mol based on 1 mol of the dedoped polyaniline.

[2] Production of Temperature Sensor Element

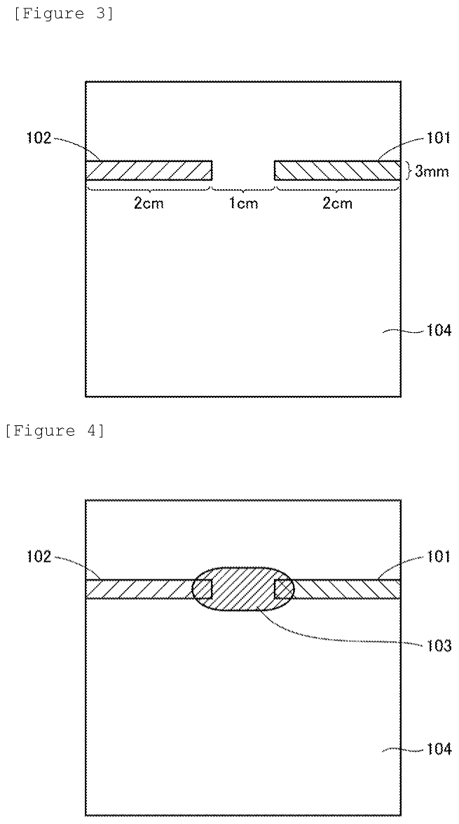

The production procedure of a temperature sensor element is described with reference to FIG. 3 and FIG. 4.

A pair of rectangular Au electrodes of 2 cm in length×3 mm in width was formed on one surface of a glass substrate (“Eagle XG” manufactured by Corning Incorporated) of a 5-cm square by sputtering using Ioncoater (“IB-3” manufactured by Eiko Corporation), with reference to FIG. 3.

The thickness of each of the Au electrodes according to cross section observation with a scanning electron microscope (SEM) was 200 nm.

Next, 200 μL of the polymer composition for a temperature-sensitive film, prepared in [1], was dropped between the pair of Au electrodes formed on the glass substrate, with reference to FIG. 4. A film of the polymer composition for a temperature-sensitive film, formed by the dropping, was in contact with both the electrodes. Thereafter, the film was subjected to a drying treatment at 50° C. under normal pressure for 2 hours and then at 50° C. under vacuum for 2 hours, and thereafter a heat treatment at 100° C. for about 1 hour, thereby forming a temperature-sensitive film and producing a temperature sensor element. The thickness of the temperature-sensitive film was measured with Dektak KXT (manufactured by Bruker), and was 30 μm.

The data of the average electric resistance value at each temperature, obtained in the following [Evaluation of temperature sensor element] (1), was subjected to fitting according to the expression (A), and the following was thus found: ρ₀=16.52 and T₀=6151.

### Example 2

A polymer composition for a temperature-sensitive film was prepared by mixing 0.480 g of the solution of dedoped polyaniline prepared in Production Example 1, 0.876 g of NMP (Tokyo Chemical Industry Co., Ltd.), 0.700 g of polyimide solution (1) as matrix resin 1 prepared in Production Example 2, and 0.024 g of (+)-camphorsulfonic acid (Tokyo Chemical Industry Co., Ltd.) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

The data of the average electric resistance value at each temperature, obtained in the following [Evaluation of temperature sensor element] (1), was subjected to fitting according to the expression (A), and the following was thus found: ρ₀=1.24 and T₀=6131.

### Example 3

A polymer composition for a temperature-sensitive film was prepared by mixing 0.640 g of the solution of dedoped polyaniline prepared in Production Example 1, 0.968 g of NMP (Tokyo Chemical Industry Co., Ltd.), 0.600 g of polyimide solution (1) as matrix resin 1 prepared in Production Example 2, and 0.032 g of (+)-camphorsulfonic acid (Tokyo Chemical Industry Co., Ltd.) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

The data of the average electric resistance value at each temperature, obtained in the following [Evaluation of temperature sensor element] (1), was subjected to fitting according to the expression (A), and the following was thus found:ρ₀=0.71 and T₀=6431.

### Example 4

A polymer composition for a temperature-sensitive film was prepared by mixing 0.800 g of the solution of dedoped polyaniline prepared in Production Example 1, 1.060 g of NMP (Tokyo Chemical Industry Co., Ltd.), 0.500 g of polyimide solution (1) as matrix resin 1 prepared in Production Example 2, and 0.040 g of (+)-camphorsulfonic acid (Tokyo Chemical Industry Co., Ltd.) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

The data of the average electric resistance value at each temperature, obtained in the following [Evaluation of temperature sensor element] (1), was subjected to fitting according to the expression (A), and the following was thus found: ρ₀=0.53 and T₀=6515.

### Example 5

A polymer composition for a temperature-sensitive film was prepared by mixing 0.960 g of the solution of dedoped polyaniline prepared in Production Example 1, 1.152 g of NMP (Tokyo Chemical Industry Co., Ltd.), 0.400 g of polyimide solution (1) as matrix resin 1 prepared in Production Example 2, and 0.048 g of (+)-camphorsulfonic acid (Tokyo Chemical Industry Co., Ltd.) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

The data of the average electric resistance value at each temperature, obtained in the following [Evaluation of temperature sensor element] (1), was subjected to fitting according to the expression (A), and the following was thus found: ρ₀=0.49 and T₀=6414.

### Example 6

A polymer composition for a temperature-sensitive film was prepared by mixing 1.120 g of the solution of dedoped polyaniline prepared in Production Example 1, 1.244 g of NMP (Tokyo Chemical Industry Co., Ltd.), 0.300 g of polyimide solution (1) as matrix resin 1 prepared in Production Example 2, and 0.056 g of (+)-camphorsulfonic acid (Tokyo Chemical Industry Co., Ltd.) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

The data of the average electric resistance value at each temperature, obtained in the following [Evaluation of temperature sensor element] (1), was subjected to fitting according to the expression (A), and the following was thus found: ρ₀=0.41 and T₀=6481.

### Example 7

A polymer composition for a temperature-sensitive film was prepared by mixing 1.280 g of the solution of dedoped polyaniline prepared in Production Example 1, 1.336 g of NMP (Tokyo Chemical Industry Co., Ltd.), 0.200 g of polyimide solution (1) as matrix resin 1 prepared in Production Example 2, and 0.064 g of (+)-camphorsulfonic acid (Tokyo Chemical Industry Co., Ltd.) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

The data of the average electric resistance value at each temperature, obtained in the following [Evaluation of temperature sensor element] (1), was subjected to fitting according to the expression (A), and the following was thus found: ρ₀=0.32 and T₀=6521.

### Example 8

A polymer composition for a temperature-sensitive film was prepared by mixing 1.120 g of the solution of dedoped polyaniline prepared in Production Example 1, 1.244 g of NMP (Tokyo Chemical Industry Co., Ltd.), 0.300 g of polystyrene solution (1) as matrix resin 2 prepared in Production Example 3, and 0.056 g of (+)-camphorsulfonic acid (Tokyo Chemical Industry Co., Ltd.) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

The data of the average electric resistance value at each temperature, obtained in the following [Evaluation of temperature sensor element] (1), was subjected to fitting according to the expression (A), and the following was thus found: ρ₀=5.59 and T₀=10217.

### Example 9

A polymer composition for a temperature-sensitive film was prepared by mixing 1.120 g of the solution of dedoped polyaniline prepared in Production Example 1, 1.244 g of NMP (Tokyo Chemical Industry Co., Ltd.), 0.300 g of polyvinyl alcohol solution (1) as matrix resin 3 prepared in Production Example 4, and 0.056 g of (+)-camphorsulfonic acid (Tokyo Chemical Industry Co., Ltd.) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

The data of the average electric resistance value at each temperature, obtained in the following [Evaluation of temperature sensor element] (1), was subjected to fitting according to the expression (A), and the following was thus found: ρ₀=21.94 and T₀=5629.

### Comparative Example 1

A polymer composition for a temperature-sensitive film was prepared by mixing 1.600 g of the solution of dedoped polyaniline prepared in Production Example 1, 1.520 g of NMP (Tokyo Chemical Industry Co., Ltd.), and 0.080 g of (+)-camphorsulfonic acid (Tokyo Chemical Industry Co., Ltd.) as a dopant. The dopant was used in an amount of 1.6 mol based on 1 mol of the dedoped polyaniline.

A temperature sensor element was produced in the same manner as in Example 1 except that the polymer composition for a temperature-sensitive film was used. The thickness of the temperature-sensitive film was measured in the same manner as in Example 1, and was 30 μm.

Table 1 shows the content (by mass) of the matrix resin (polyimide, polystyrene or polyvinyl alcohol) in the temperature-sensitive film based on the mass of the temperature-sensitive film of the temperature sensor element of 100% by mass. The content of the matrix resin (polyimide, polystyrene, or polyvinyl alcohol) in the composition based on the solid content of the polymer composition for a temperature-sensitive film, of 100% by mass, is also the same as the value shown in Table 1.

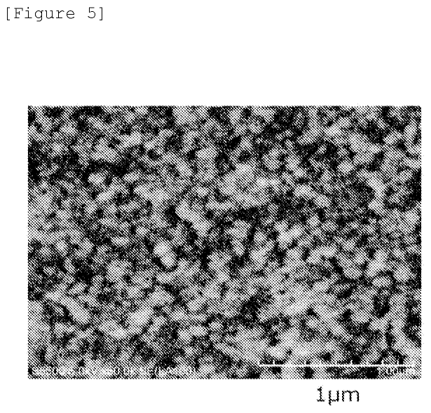

FIG. 5 illustrates a SEM photograph imaging a cross section of the temperature-sensitive film in the temperature sensor element produced in Example 2. A white-photographed portion corresponded to conductive domains dispersed in the matrix resin.

[Evaluation of Temperature Sensor Element]

(1) Temperature Dependence of Electric Resistance Value

The pair of Au electrodes in the temperature sensor element and a digital multimeter (“B35T+” manufactured by OWON Japan) were connected with a lead wire. The temperature of the temperature sensor element was adjusted by use of a Peltier temperature controller (“HMC-10F-0100” manufactured by Hayashi-Repic Co., Ltd.), and the average electric resistance value at the temperature (each of eight points at 10° C., 20° C., 30° C., 40° C., 50° C., 60° C., 70° C. and 80° C.) was measured.

Specifically, the temperature of the temperature sensor element was first adjusted to 10° C. by use of the Peltier temperature controller, and this temperature was retained for 0.5 hours. The average with respect to the electric resistance value for such 0.5 hours was measured as the average electric resistance value at 10° C. Next, the temperature of the temperature sensor element was adjusted to 20° C., and this temperature was retained for 0.5 hours. The average with respect to the electric resistance value for such 0.5 hours was measured as the average electric resistance value at 20° C. The average with respect to the electric resistance value for a retention time of 0.5 hours at each temperature at six points, other than 10° C. and 20° C., was also measured in the same manner, as the average electric resistance value at such each temperature. The temperature of the temperature sensor element was sequentially raised from 10° C. to 80° C.

The d(R/dT) [unit: kΩ/° C.] represented by the following expression with the average electric resistance value Rₐᵥₑ₃₀ at 30° C. and the average electric resistance value Rₐᵥₑ₄₀ at 40° C. among the above measurement values was used as an index indicating the temperature dependence of the electric resistance value of the temperature sensor element. The value of d(R/dT) is shown in Table 1.

d(R/dT)=(Rₐᵥₑ₃₀−Rₐᵥₑ₄₀)/10

(2) Measurement Accuracy Converted into Temperature

The measurement accuracy T_{A} (° C.) of the temperature sensor element was calculated according to the following expression. The following expression indicates the amount of change in temperature measured by the temperature sensor element, corresponding to d(R/dT), in a case where the electric resistance value that can be detected by the temperature sensor element is assumed to be 0.1 kΩ or more and the electric resistance value is changed by 0.1 kΩ.

T_{A}=0.1/[d(R/dT)]

The measurement accuracy T_{A} calculated according to the expression is shown in Table 1.

The measurement accuracy T_{A} means precision of a measurable temperature at a detectable electric resistance value of 0.1 kΩ or more. It is meant that, as the measurement accuracy T_{A} is smaller, the temperature sensor element can more reliably measure the temperature and the accuracy of temperature measurement is higher.

(3) Durability Over Time of Temperature-Sensitive Film (Certain Rate of Change ΔR in Resistance Value at 80° C.)

A Peltier temperature controller was used to keep the temperature of the temperature sensor element to 80° C. constantly, and the rate of change ΔR in electric resistance value was calculated by using the following expression with the electric resistance value R₅ₘᵢₙ after 5 minutes and the electric resistance value R₃ₕ after 3 hours. The calculation results are shown together in Table 1. As the rate of change ΔR was lower, the temperature-sensitive film exhibited more excellent durability over time.

ΔR=100×|R₃ₕ−R₅ₘᵢₙ|/R₅ₘᵢₙ

TABLE 1

| | | | | Rate of |
|---|---|---|---|---|
| | | | | change in |
| | | Temperature | Measurement | electric |
| | Content | dependence | accuracy | resistance |
| | of matrix | of electric | converted | value at |
| | resin | resistance | into | constant |
| | (% by | value | temperature | 80° C. |
| | mass) | d (R/dT) | T_{A} (° C.) | ΔR (%) |
| Example 1 | 66.67 | 39.78 | 0.003 | 0.32 |
| Example 2 | 53.85 | 2.91 | 0.034 | 0.36 |
| Example 3 | 42.86 | 2.25 | 0.045 | 0.41 |
| Example 4 | 33.33 | 1.81 | 0.055 | 0.38 |
| Example 5 | 25.00 | 1.52 | 0.066 | 0.39 |
| Example 6 | 17.65 | 1.36 | 0.073 | 0.44 |
| Example 7 | 11.11 | 1.07 | 0.094 | 1.81 |
| Example 8 | 17.65 | 1.36 | 0.0002 | 4.24 |
| Example 9 | 17.65 | 1.36 | 0.004 | 5.67 |
| Comparative | 0.00 | 0.91 | 0.11 | 8.30 |
| Example 1 | | | | |

### REFERENCE SIGNS LIST

100 temperature sensor element, 101 first electrode, 102 second electrode, 103 temperature-sensitive film, 103a matrix resin, 103b conductive domain, 104 substrate.

1. A temperature sensor element comprising a pair of electrodes and a temperature-sensitive film disposed in contact with the pair of electrodes, wherein
the temperature-sensitive film comprises a conjugated polymer and a matrix resin.

2. The temperature sensor element according to claim 1, wherein
the temperature-sensitive film comprises the matrix resin and a plurality of conductive domains contained in the matrix resin, and
the conductive domains comprise the conjugated polymer and a dopant.

3. The temperature sensor element according to claim 1, wherein the matrix resin comprises a polyimide-based resin.

4. The temperature sensor element according to claim 3, wherein the polyimide-based resin comprises an aromatic ring.

5. The temperature sensor element according to claim 1, wherein a content of the matrix resin is 10% by mass or more and 90% by mass or less based on a mass of the temperature-sensitive film of 100% by mass.
